(19) United States
(12) Patent Application Publication
(10) Pub. No.: US 2007/0020056 A1
(43) Pub. Date: Jan. 25, 2007

(54) Hole saw replacement blade rings

(76) Inventor: Brett W. Burdick, Clinton, CT (US)

Correspondence Address: Brett Whitlock Burdick, 16 Country Village Lane, Clinton, CT, 06413, US

(21) Appl. No.: 11/060,731

(22) Filed: Jan. 24, 2005

(51) Int. Cl. B23B 51/04

(52) U.S. Cl. 408/204

(57) ABSTRACT

To save time and money by separating the main housing from the blade. The trail leg saw teeth also makes it easier for the stock to be removed. There is also a drill tip and sleeve combination that slides out to remove stock easily.

1. I have invented a new design for the holesaw as set forth in the following specifications:

DRAWING 1.

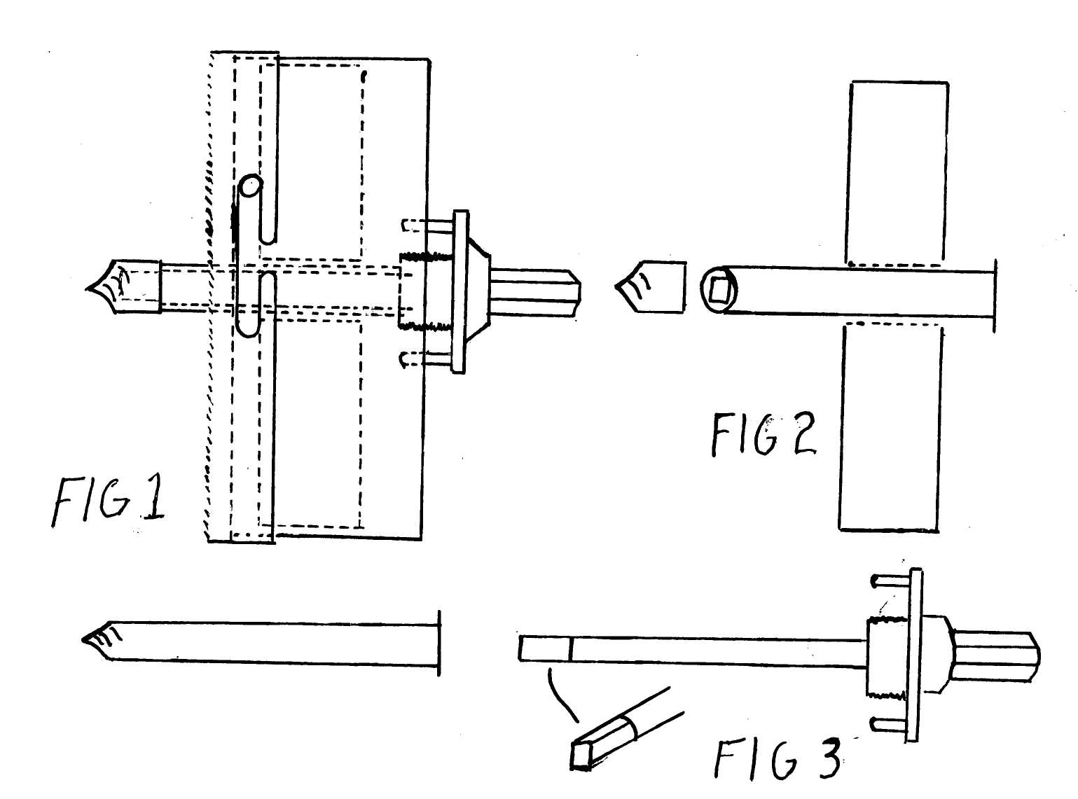

FIG. 1. Is the side view of a new holesaw with replacement ring saw shoes with removeable stock.

FIG. 2. Is the stock that is being removed with the sleeve.

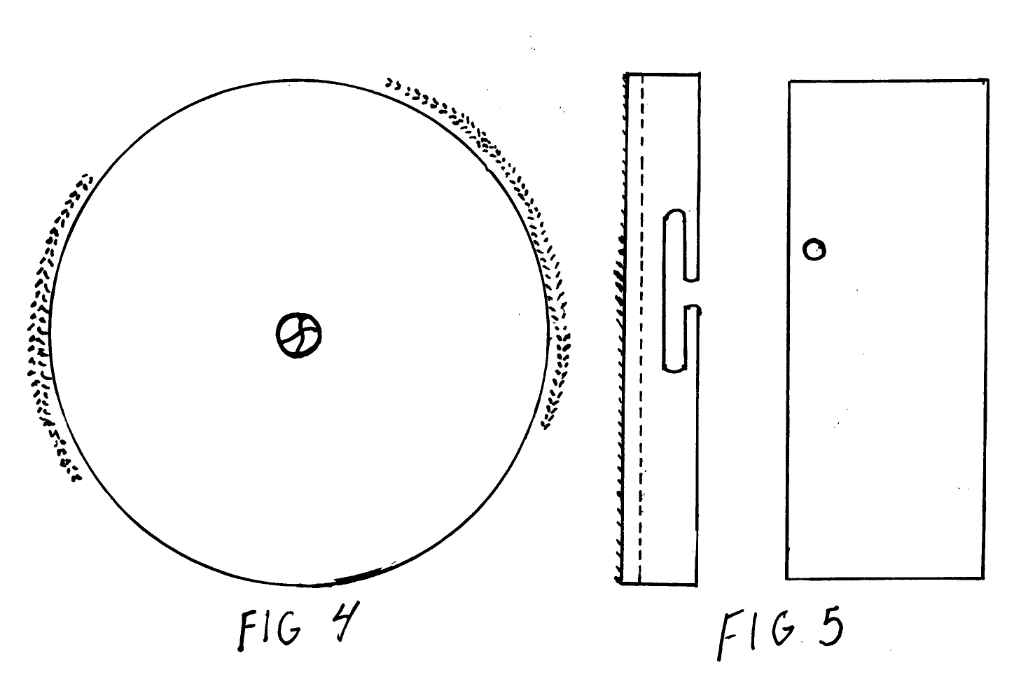

FIG. 3. Shows the replacement tip being removed and then the sleeve is ready to remove stock. The replacement tip and the sleeve could be the same diameter.

DRAWING 2

FIG. 4. Is showing the trail leg saw teeth from the front.

FIG. 5. Is showing the replacement blade ring shoes removed.

What is claimed is:

1. Holesaw mount and ring cutter shoes are separated for Replaceplace rings.

2. The blade has trail leg saw teeth to free stock easily.

3. Drill tip is re-moveable to allow a larger hole in stock, to free stock And allow sleeve to be removed.

4. Replacement rings can be attached from 1′ to 6′ or greater.

5. Holesaw catch so the ring shoe cutter and holesaw are locked together.

6. The drill bit and the sleeve could be joined together as one unit.

7. The blade design can be replaceable or molded like your standard saw.

8 Drill tip could be used for future replacement drill tips.

9. The replacement saw rings could have 2 or 4 trail saw legs.

10. The sleeve at the end could have a square notch at the end to lock.
